(19) United States
(12) Patent Application Publication
(10) Pub. No.: US 2026/0171960 A1
(43) Pub. Date: Jun. 18, 2026

(54) PHOTOVOLTAIC MOBILE POWER SUPPLY DEVICE

(71) Applicant: GUANGDONG BILIGHT INTELLIGENT MANUFACTURING TECHNOLOGY CO., LTD., Dongguan (CN)

(72) Inventors: Kuan-Jung CHEN, Dongguan (CN); Wei-Chia FANG, Dongguan (CN); Chung-Chin HSIAO, Dongguan (CN); Tzu-Chien WEI, Dongguan (CN)

(21) Appl. No.: 19/367,934

(22) Filed: Oct. 24, 2025

(30) Foreign Application Priority Data
Dec. 12, 2024 (CN) 202411838648.6

(51) Int. Cl. H02S 30/20; H02S 20/32

(52) U.S. Cl. CPC H02S 30/20; H02S 20/32

(57) ABSTRACT

A photovoltaic mobile power supply device which includes a base and an upper cover rotatably connected to the base and capable of being flipped relative to the base into a folded position. A first solar panel assembly made of a perovskite material is disposed on inner folding surfaces of the base and upper cover, while a second solar panel assembly is disposed on outer unfolding surfaces of the base and upper cover. Depending on usage conditions, the photovoltaic mobile power supply device can be either deployed or folded. In cases of strong sunlight, the photovoltaic mobile power supply device can be folded to generate electricity via the second solar panel assembly. Conversely, in situations of weaker sunlight, the photovoltaic mobile power supply device can be deployed to expose the first solar panel assembly and electricity is generated through the first solar panel assembly, which achieves higher power generation efficiency.

### CROSS-REFERENCE TO RELATED APPLICATION

Pursuant to 35 U.S.C. § 119 and the Paris Convention, this application claims the benefit of Chinese Patent Application No. 202411838648.6 filed on Dec. 12, 2024, the content of which is incorporated herein by reference.

### FIELD OF TECHNOLOGY

The following relates to the field of portable power bank technology, more particularly to a photovoltaic mobile power supply device.

### BACKGROUND

The statements provided herein are merely background information related to the present application, and do not necessarily constitute any prior arts. Currently, solar panels in existing solar-powered mobile power banks primarily use polycrystalline silicon or monocrystalline silicon as the light-absorbing layer material. The photoelectric conversion efficiency of crystalline silicon light-absorbing layers is very low under indoor lighting conditions. Therefore, conventional solar-powered mobile power banks cannot effectively utilize indoor light sources for solar charging.

### SUMMARY

It is an objective of the present application to provide a photovoltaic mobile power supply device, which addresses the low indoor power generation efficiency of conventional solar-powered mobile power banks.

In accordance with a first aspect of embodiments of the present application, a photovoltaic mobile power supply device is provided, which includes: a base; and an upper cover rotatably connected to the base and capable of flipping relative to the base to form a folded configuration. A first solar panel assembly made of perovskite is disposed on inner folding surfaces of the base and the upper cover, and a second solar panel assembly is disposed on outer unfolding surfaces of the base and the upper cover.

In one embodiment, the second solar panel assembly is a polycrystalline silicon or monocrystalline silicon solar panel assembly.

In one embodiment, the first solar panel assembly includes an upper-cover inner-side solar panel disposed on the inner folding surface of the upper cover and a base inner-side solar panel disposed on the inner folding surface of the base. The upper-cover inner-side solar panel and the base inner-side solar panel face each other in the folded configuration. The second solar panel assembly includes an upper-cover backside solar panel disposed on the outer unfolding surface of the upper cover and a base backside solar panel disposed on the outer unfolding surface of the base. The upper-cover backside solar panel and the base backside solar panel face away from each other in the folded configuration.

In one embodiment, a power management module is disposed within the upper cover and/or the base, and an output interface electrically connected to the power management module is provided on the upper cover and/or the base. The first solar panel assembly and the second solar panel assembly are respectively electrically connected to the power management module.

In one embodiment, an energy storage module is disposed within the upper cover and/or the base, and the energy storage module is electrically connected to the power management module.

In one embodiment, a display module electrically connected to the power management module is provided on the upper cover and/or the base.

In one embodiment, the photovoltaic mobile power supply device includes a rotation mechanism hinged to the upper cover and the base, and the rotation mechanism is capable of controlling an included angle between the upper cover and the base.

In one embodiment, the rotation mechanism includes a motorized shaft electrically connected to the power management module. The power management module is capable of controlling a rotation of the motorized shaft to deploy the upper cover and the base relative to each other when a power generation capacity of the photovoltaic mobile power supply device falls below a preset threshold.

In one embodiment, a photosensitive module capable of sensing ambient light intensity is also provided on the upper cover and/or the base. The photosensitive module is electrically connected to the power management module, and the power management module is capable of controlling the rotation of the motorized shaft to fold or deploy the upper cover and the base based on the ambient light intensity sensed by the photosensitive module.

In one embodiment, the base is provided with a support structure for contact support with an external surface.

Compared with existing technologies, the embodiments of the present application have at least the following beneficial effects: By employing the base and the upper cover that is rotatably connected to the base and capable of flipping relative to the base to form the folded configuration, the photovoltaic mobile power supply device can be adjusted to either the folded configuration or the deployed configuration. Since the first solar panel assembly made of perovskite material is provided on the inner folding surfaces of the base and the upper cover, the photovoltaic mobile power supply device can be selectively deployed or folded based on usage conditions. In cases of strong sunlight, the photovoltaic mobile power supply device can be folded to generate electricity via the second solar panel assembly, whereas in situations of weaker sunlight, the photovoltaic mobile power supply device can be deployed to expose the first solar panel assembly, and electricity is generated through the first solar panel assembly which achieves higher power generation efficiency.

### BRIEF DESCRIPTION OF THE DRAWINGS

FIG. 1 is a schematic structural diagram of a photovoltaic mobile power supply device in a folded configuration according to an embodiment of the present application;

FIG. 2 is a schematic structural diagram of a photovoltaic mobile power supply device in a deployed configuration according to an embodiment of the present application; and

FIG. 3 is another schematic structural diagram of a photovoltaic mobile power supply device according to an embodiment of the present application.

In the figures, reference numerals are listed as follows:

100, base; 200, upper cover; 300, first solar panel assembly; 310, upper-cover inner-side solar panel; 320, base inner-side solar panel; 400, second solar panel assembly; 410, upper-cover backside solar panel; 420, base backside solar panel; 510, power management module; 520, output interface; 600, rotation mechanism.

### DETAILED DESCRIPTION OF THE EMBODIMENTS

To clarify the technical problems to be solved, technical schemes and beneficial effects of the present application, the present application is further described in detail in conjunction with the accompanying drawings and embodiments. It should be understood that the specific embodiments described herein are intended only to illustrate the present application and are not intended to limit the present application.

It should be noted that when an element is referred to as being "fixed to" or "disposed on" another element, it may be directly or indirectly on the other element. When an element is referred to as being "connected to" another element, it may be directly or indirectly connected to the other element.

In addition, the terms "first" and "second" are used for descriptive purposes only and should not be understood as indicating or suggesting relative importance or implicitly indicating the quantity of the technical features indicated. Thus, a feature defined as "first" or "second" may explicitly or implicitly include one or more of such features. In the description of this application, the phrase "a/the plurality of" means two or more, unless otherwise explicitly and specifically limited.

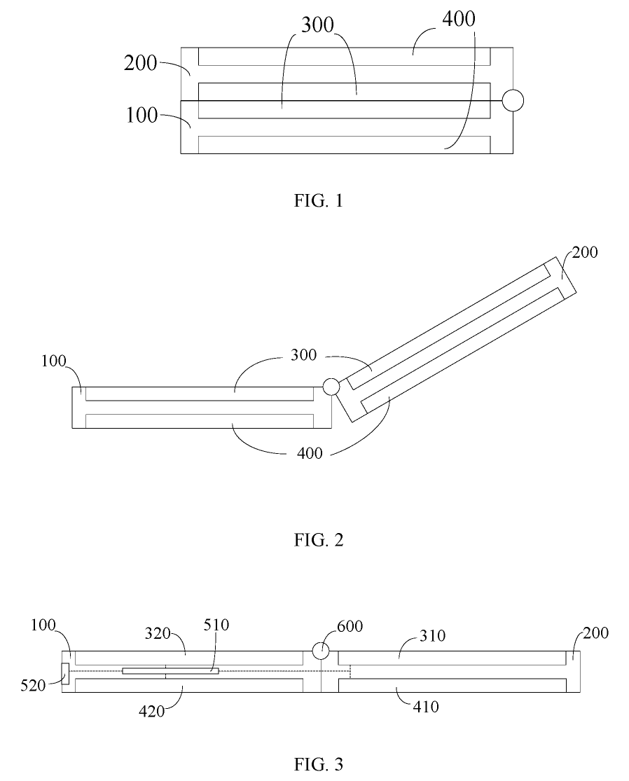

FIG. 1 shows a schematic structural diagram of a power device provided in one embodiment of the present application. For ease of illustration, only the portions relevant to this embodiment are shown. The details are as follows:

The photovoltaic mobile power supply device includes a base 100 and an upper cover 200 that is rotatably connected to the base 100 and capable of flipping relative to the base 100 to form a folded configuration.

Here, a first solar panel assembly 300 made of perovskite is disposed on inner folding surfaces of the base 100 and upper cover 200, while a second solar panel assembly 400 is disposed on outer unfolding surfaces of the base 100 and upper cover 200.

The photovoltaic mobile power supply device can be adjusted between a folded configuration and a deployed configuration by means of the base 100 and the upper cover 200 which is rotatably connected to the base 100 and capable of flipping relative to the base 100 to form the folded configuration. In some embodiments, when the photovoltaic mobile power supply device is folded, an included angle between the base 100 and the upper cover 200 is approximate to 0 degrees. When the photovoltaic mobile power supply device is deployed, the included angle between the base 100 and the upper cover 200 may range from 90 degrees to 180 degrees.

As a new generation of solar power generation material, the first solar panel assembly 300 made of perovskite has higher energy conversion efficiency. Thus, in low light conditions, the photovoltaic mobile power supply device can be adjusted to the deployed configuration to generate electricity through the first solar panel assembly 300, achieving higher power output. The folded photovoltaic mobile power supply device is also convenient for storage.

The photovoltaic mobile power supply device can provide temporary power to indoor IoT (Internet of Things) devices, sensors, electronic photo frames, and mobile devices. The photovoltaic mobile power supply device can also provide temporary power to electronic devices outdoors where grid power is unavailable.

The base 100 and the upper cover 200 may include a fixing structure for securing the solar panel assembly. For example, the base 100 and the upper cover 200 may include a fixing plate or a fixing bracket.

In one embodiment, the second solar panel assembly 400 is a polycrystalline or monocrystalline silicon solar panel assembly.

Compared to the perovskite-based first solar panel assembly 300, the polycrystalline or monocrystalline silicon solar panel assembly has lower energy conversion efficiency, but they are less expensive and more versatile. In bright outdoor conditions, the photovoltaic mobile power supply device can be adjusted to the folded configuration and then deployed at a certain angle, forming an inverted V-shape, to generate electricity using the second solar panel assembly 400. Even with lower energy conversion efficiency, the second solar panel assembly 400 can still meet power generation needs and also withstand more hazardous outdoor environments, extending the device’s service life.

In one embodiment, the first solar panel assembly 300 includes an upper-cover inner-side solar panel 310 disposed on the inner folding surface of the upper cover 200 and a base inner-side solar panel 320 disposed on the inner folding surface of the base 100. The upper-cover inner-side solar panel 310 and the base inner-side solar panel 320 facing each other in the folded configuration. The second solar panel assembly 400 includes an upper-cover backside solar panel 410 disposed on the outer unfolding surface of the upper cover 200 and a base backside solar panel 420 disposed on the outer unfolding surface of the base 100. The upper-cover backside solar panel 410 and the base backside solar panel 420 facing away from each other in the folded configuration.

The upper-cover inner-side solar panel 310 and the base inner-side solar panel 320 may be perovskite solar panels, while the upper-cover backside solar panel 410 and the base backside solar panel 420 may be polycrystalline silicon or monocrystalline silicon solar panels.

It is understood that when the photovoltaic mobile power supply device is in the deployed configuration, the upper-cover inner-side solar panel 310 and the base inner-side solar panel 320 are located on the same side, while the upper-cover backside solar panel 410 and the base backside solar panel 420 are located on the opposite side.

In some embodiments, the upper-cover backside solar panel 410 and the base backside solar panel 420 may be thin-film solar panels.

In one embodiment, a power management module 510 is disposed within the upper cover 200 and/or the base 100, and an output interface 520 electrically connected to the power management module 510 is provided on the upper cover 200 and/or the base 100. The first solar panel assembly 300 and the second solar panel assembly 400 are each electrically connected to the power management module 510.

Specifically, the power management module 510 may include a processor and a power conversion circuit. The power conversion circuit is connected to each solar power generation module and each output interface 520, and the processor is connected to the power conversion circuit. When an external power-consuming device is connected to the output interface 520, the processor may control an output of the power conversion circuit based on the actual power consumption of the external power-consuming device to meet the power demand of the external power-consuming device.

Specific locations of the power management module 510 and the output interface 520 may be configured according to actual needs.

In some embodiments, the output interface 520 includes a USB interface, a Type-C interface, or other interfaces.

In some embodiments, the base 100 is provided with multiple output interfaces 520 to enable simultaneous charging of multiple devices.

In one embodiment, an energy storage module is disposed within the upper cover 200 and/or the base 100 and is electrically connected to the power management module 510. The energy storage module may include a battery pack.

Specifically, the energy storage module may be connected to the processor and the power conversion circuit. When a total power generated by the photovoltaic mobile power supply device can meet the power needs of external power devices or when no external power device is connected to the photovoltaic mobile power supply device, the processor may control the power conversion circuit to charge the energy storage module. If the total power generated by the photovoltaic mobile power supply device cannot meet the power needs of external power devices, the processor may control the energy storage module to supply power to the external power devices.

In some embodiments, the energy storage module is disposed within the base 100.

In one embodiment, a display module electrically connected to the power management module 510 is provided on the upper cover 200 and/or the base 100. The display module may include a liquid crystal display for human-computer interaction.

The display module may be connected to the power management module 510 and may be used to display a real-time power generated by the photovoltaic mobile power supply device, a remaining power of the energy storage module, or other real-time operating parameters of the photovoltaic mobile power supply device.

In one embodiment, the photovoltaic mobile power supply device includes a rotation mechanism 600 hinged to the upper cover 200 and the base 100. The rotation mechanism 600 is configured to control the included angle between the upper cover 200 and the base 100.

According to the incident light angle, the rotation mechanism 600 can adjust the included angle between the upper cover 200 and the base 100 to position the upper cover 200 perpendicular to the light irradiation direction, thereby, the photovoltaic mobile power supply device is enabled to operate at the peak power generation capacity.

In one embodiment, the rotation mechanism 600 includes a motorized shaft electrically connected to the power management module 510. The power management module 510 is configured to control the motorized shaft to rotate, allowing the upper cover 200 and the base 100 to be deployed relative to each other when a power generation capacity of the photovoltaic mobile power supply device falls below a preset threshold.

It is understandable that due to the high energy conversion efficiency of the first solar panel assembly 300 on the inner side, if the power generation capacity of the photovoltaic mobile power supply device falls below the preset threshold, the power management module 510 may automatically control the upper cover 200 and the base 100 to be deployed relative to each other through the motorized shaft. This enhances the device’s power generation capacity to meet power demands. The preset threshold may be set according to actual needs.

In one embodiment, the upper cover 200 and/or the base 100 are further provided with a photosensitive module capable of sensing ambient light intensity. The photosensitive module is electrically connected to the power management module 510. The power management module 510 is configured control the rotation of the motorized shaft to fold or deploy the upper cover 200 and base 100 based on the ambient light intensity sensed by the photosensitive module.

When the included angle between the upper cover 200 and the base 100 is fixed, the ambient light intensity is generally positively correlated with the power generated by the photovoltaic mobile power supply device. Thus, the power management module 510 may determine whether the current power generation output meets basic power requirements based on the ambient light intensity and the included angle between the upper cover 200 and the base 100. When the ambient light intensity is low, the power management module 510 may control the motorized shaft to rotate to deploy the upper cover 200 and the base 100, utilizing the first solar panel assembly 300 as the primary power generation module to improve power generation efficiency. When the ambient light intensity is sufficient, the power management module 510 may control the motorized shaft to rotate to deploy the upper cover 200 and the base 100, utilizing the second solar panel assembly 400 as the primary power generation module to provide protection for the first solar panel assembly 300.

In one embodiment, the base 100 is provided with a support structure configured for contact support with an external surface.

The support structure may include anti-slip pads or support feet for contact with the ground, or a fixing structure for securing the device to the external surface.

In some embodiments, protective frames are further provided along peripheral side edges of the base 100 and the upper cover 200, with anti-collision parts disposed at corners of the side edges of both the upper cover 200 and the base 100.

If the photovoltaic mobile power supply device is frequently moved, the first solar panel assembly 300 and the second solar panel assembly 400 are easily damaged by external impact, and damage is difficult to repair. The protective frames and the anti-collision parts can improve the portability of the photovoltaic mobile power supply device, reduce the risk of damage to the first solar panel assembly 300 and the second solar panel assembly 400, and extend the device’s service life.

In summary, by means of the base 100 and the upper cover 200 which is rotatably connected to the base 100 and capable of flipping relative to the base 100 to form the folded configuration, the photovoltaic mobile power supply device is allowed to be adjusted to either the folded or deployed configuration.

In the folded configuration, the photovoltaic mobile power supply device can be secured outdoors using a support structure. In this configuration, the photovoltaic mobile power supply device primarily generates electricity from the second solar panel assembly 400 on one side. Alternatively, the photovoltaic mobile power supply device can be deployed at a certain angle, arranged in an inverted V configuration, with the second solar panel assembly 400 on both sides generating electricity. The second solar panel assembly 400 has lower power generation efficiency than the first solar panel assembly 300, but strong outdoor sunlight is sufficient to meet power generation demands, and the second solar panel assembly 400 is more adaptable to outdoor environments than the first solar panel assembly 300.

In the deployed configuration, the second solar panel assembly 400 can be oriented toward the light source for power generation, or the first solar panel assembly 300 can be oriented toward the light source for power generation. Compared to the second solar panel assembly 400, the perovskite-based first solar panel assembly 300 has higher energy conversion efficiency, which thus can achieve higher power generation efficiency even in indoor environments with low light intensity.

The photovoltaic mobile power supply device of this embodiment can serve as a mobile power source to and can be placed in different positions according to demands, while also being able to switch among different postures based on varying light conditions to achieve high-efficiency power generation.

Persons skilled in the art will clearly understand that, for the sake of convenience and brevity, the division of the above functional units and modules is used only as an example. In actual applications, the above functions may be assigned to different functional units or modules as needed. That is, the internal structure of the device may be divided into different functional units or modules to perform all or part of the functions described above. The functional units and modules in the embodiments may be integrated into a single processing unit, each unit may exist physically alone, or two or more units may be integrated into a single unit. These integrated units may be implemented as either hardware or software functional units. Furthermore, the specific names of the functional units and modules are for ease of distinction only and are not intended to limit the protection scope of the present application. Specific operating processes of the units and modules in the above-mentioned systems may be referenced to the corresponding processes in the aforementioned method embodiments and will not be elaborated upon here.

In the above-mentioned embodiments, the descriptions of each embodiment have their own specific focus. For portions not described or detailed in a particular embodiment, reference should be made to the relevant descriptions of other embodiments.

The above-mentioned embodiments are intended only to illustrate the technical solutions of the present application and are not intended to limit them. Although the present application has been described in detail with reference to the aforementioned embodiments, persons of ordinary skill in the art should understand that modifications may be made to the technical solutions described in the aforementioned embodiments, or that some of the technical features therein may be replaced with equivalents. Such modifications or replacements do not deviate from the spirit and scope of the technical solutions of the various embodiments of the present application and thus should all be included within the protection scope of the present application.

What is claimed is:

1. A photovoltaic mobile power supply device, comprising:
a base; and
an upper cover, rotatably connected to the base and capable of flipping relative to the base to form a folded configuration, wherein a first solar panel assembly made of a perovskite material is disposed on an inner folding surface of the base and an inner folding surface of the upper cover, and a second solar panel assembly is disposed on an outer unfolding surface of the base and an outer unfolding surface of the upper cover.

2. The photovoltaic mobile power supply device according to claim 1, wherein the second solar panel assembly is a polycrystalline silicon or monocrystalline silicon solar panel assembly.

3. The photovoltaic mobile power supply device according to claim 2, wherein:
the first solar panel assembly comprises an upper-cover inner-side solar panel disposed on the inner folding surface of the upper cover and a base inner-side solar panel disposed on the inner folding surface of the base, with the upper-cover inner-side solar panel and the base inner-side solar panel facing each other in the folded configuration; and
the second solar panel assembly comprises an upper-cover backside solar panel disposed on the outer unfolding surface of the upper cover and a base backside solar panel disposed on the outer unfolding surface of the base, with the upper-cover backside solar panel and the base backside solar panel facing away from each other in the folded configuration.

4. The photovoltaic mobile power supply device according to claim 1, wherein a power management module is disposed within the upper cover and/or the base, and an output interface electrically connected to the power management module is provided on the upper cover and/or the base, and the first solar panel assembly and the second solar panel assembly are respectively electrically connected to the power management module.

5. The photovoltaic mobile power supply device according to claim 4, wherein an energy storage module is disposed within the upper cover and/or the base, and the energy storage module is electrically connected to the power management module.

6. The photovoltaic mobile power supply device according to claim 4, wherein a display module electrically connected to the power management module is provided on the upper cover and/or the base.

7. The photovoltaic mobile power supply device according to claim 4, wherein the photovoltaic mobile power supply device comprises a rotation mechanism hinged to the upper cover and the base, and the rotation mechanism is capable of controlling an included angle between the upper cover and the base.

8. The photovoltaic mobile power supply device according to claim 7, wherein the rotation mechanism comprises a motorized shaft electrically connected to the power management module, the power management module is capable of controlling a rotation of the motorized shaft to deploy the upper cover and the base relative to each other when a power generation capacity of the photovoltaic mobile power supply device falls below a preset threshold.

9. The photovoltaic mobile power supply device according to claim 8, wherein a photosensitive module capable of sensing ambient light intensity is further provided on the upper cover and/or the base, the photosensitive module is electrically connected to the power management module, the power management module is capable of controlling the rotation of the motorized shaft to fold or deploy the upper cover and the base based on the ambient light intensity sensed by the photosensitive module.

10. The photovoltaic mobile power supply device according to claim 1, wherein a support structure is provided on the base for contact support with an external surface.

11. The photovoltaic mobile power supply device according to claim 2, wherein a power management module is disposed within the upper cover and/or the base, and an output interface electrically connected to the power management module is provided on the upper cover and/or the base, and the first solar panel assembly and the second solar panel assembly are respectively electrically connected to the power management module.

12. The photovoltaic mobile power supply device according to claim 3, wherein a power management module is disposed within the upper cover and/or the base, and an output interface electrically connected to the power management module is provided on the upper cover and/or the base, and the first solar panel assembly and the second solar panel assembly are respectively electrically connected to the power management module.
